(19) United States
(12) Patent Application Publication
(10) Pub. No.: US 2026/0017505 A1
(43) Pub. Date: Jan. 15, 2026

(54) Fully-Automated Analog Circuit Generator Using A Neural Network Assisted Semi-Supervised Learning Approach

(71) Applicant: The Regents of the University of Michigan, Ann Arbor, MI (US)

(72) Inventors: Ronald DRESLINSKI, Ann Arbor, MI (US); Ehsan Afshari, Ann Arbor, MI (US); Morteza Tavakoli Taba, Ann Arbor, MI (US); Morteza Fayazi, Ann Arbor, MI (US)

(73) Assignee: Innovation Partnerships, Ann Arbor, MI (US)

(21) Appl. No.: 18/444,598

(22) Filed: Feb. 16, 2024

(51) Int. Cl. G06N 3/065; G06N 3/0895

(52) U.S. Cl. CPC G06N 3/065; G06N 3/0895

(57) ABSTRACT

Machine Learning has shown promising results in predicting the behavior of analog circuits. However, in order to completely cover the design space for today's complicated circuits, supervised machine learning requires a large number of labeled samples which is time-consuming to provide. Furthermore, a separate dataset must be collected for each circuit topology making all other previously gathered datasets useless. In this disclosure, neural networks are used to determine the behavior of complicated topologies by combining simple ones. By generating a database with labeled and unlabeled data, the time for providing the training set is significantly reduced compared to the conventional approaches. Using this database, a fully-automated analog circuit generator framework is presented. The analog circuit generator performs all the schematic circuit design steps from deciding the circuit topology to determining the circuit parameters i.e. sizing.

### GOVERNMENT CLAUSE

This invention was made with government support under FA8650-18-2-7860 awarded by the U.S. Air Force Research Laboratory. The government has certain rights in the invention.

### FIELD

The present disclosure relates to fully automated circuit generation using a neural network assisted semi-supervised learning approach.

### BACKGROUND

The existence of various design parameters and specifications in present-day complex circuits, in addition to severe process variations, have made the manual circuit design procedure challenging, time-consuming, and inefficient. All these challenges make the automated analog circuit generation a necessity. Schematic circuit design includes two main steps: deciding the topology and determining the values of the circuit elements (i.e. sizing) to meet the desired specifications.

Model-based approaches are one of the main techniques in the automated sizing of circuits e.g. non-convex polynomial optimization, geometric programming, and Neural Network (NN). In such approaches, a global model is built based on the collected training set, which makes the model reusable for other data. However, to maintain high accuracy while covering the whole design space, a large labeled training set is required. SPICE simulation is used for gathering such a large set which is time-consuming. To make matters worse, a separate dataset is required for each circuit topology, even if a single element is added or removed.

Even though the model-based approaches are reusable, their accuracies are not usually high due to the large number of design parameters and nonlinearity of object and constraint functions. On the other hand, the other approaches in automated sizing, simulation-based algorithms, optimize circuits directly by the gathered simulated data and usually have higher accuracy. However, they are more time-consuming in comparison with model-based methods and are non-reusable. Here, non-reusable means that even if the target specifications slightly change, the whole process needs to reoccur. The third approach in circuit sizing is a hybrid of model- and simulation-based methods. In such approaches, after building the initial model, the model is gradually updated by running simulations during the optimization procedure instead of using an offline model.

In order to reduce the size of the labeled dataset, this disclosure proposes a co-learning-based neural network approach. The term co-learning here means passing the knowledge from usually less complex models to more complicated ones to reduce the training cost. In this case, the previously gathered datasets of simpler circuits are leveraged to shrink the required labeled training sets for more complicated circuit topologies. In other words, neural networks are used to determine the circuit behavior of complicated topologies by combining the simpler ones.

Using the presented database, a fully-automated analog circuit generator framework is presented and referred to herein as AnGeL. The goals of AnGeL are threefold: (a) achieve a reusable, accurate, and fast model to meet the given specifications of the overall circuit, (b) reduce the number of required labeled training samples, and (c) perform all schematic circuit design steps such as deciding the overall circuit topology, selecting the topology of sub-circuits, and sizing them. Since both labeled and unlabeled data are used in the database, this approach is classified as semi-supervised learning.

The section above provides background information related to the present disclosure which is not necessarily prior art.

### SUMMARY

This section provides a general summary of the disclosure, and is not a comprehensive disclosure of its full scope or all of its features.

A fully-automated analog circuit generator is presented. The analog circuit generator is comprised of an overall topology decider and a sub-circuit generator. The overall topology decider is configured to receive the desired specification for an analog circuit and operates to determine an overall topology for the analog circuit using a first machine learning algorithm, where the overall topology for the analog circuit specifies two or more sub-circuits for constructing the analog circuit and how the two or more sub-circuits are connected together. The sub-circuit generator is configured to receive the determined specification for the analog sub-circuits and the overall topology for the analog circuit from the overall topology decider module. The sub-circuit generator in turn outputs parameter values for each sub-circuit component comprising each of the two or more sub-circuits using a second machine learning algorithm, such that the second machine learning algorithm differs from the first machine learning algorithm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A depicts an example of three simple topologies input into a topology combiner.

FIG. 1B shows how the output topology of FIG. 1A is used to make a more complicated topology.

FIG. 2A depicts the general structures of three simpler topologies, T1, T2, and T3, which are combined to determine the circuit behavior of Tout along with the example of FIG. 1A.

FIGS. 2B and 2C show neural network implementations for a topology combiner.

FIG. 3 is a diagram of a high-level architecture for a fully-automated analog circuit generator.

FIG. 4A illustrates two examples of high-level circuit topologies.

FIG. 4B depicts a neural network implementation of a net-specification-calculator model.

FIG. 4C depicts an overall-specification-breaker model in a training phase.

FIG. 4D depicts an overall-specification-breaker model in a deployment phase.

FIG. 5 illustrates a constraints transformation algorithm.

FIGS. 6A-6C depict the supported high-level topologies for operational amplifiers.

FIG. 7A depicts gain block sub-circuit body structures with the range of supported design parameters written next to each in the form of [low, high].

FIG. 7B depicts gain block sub-circuit loads with the range of supported design parameters written next to each in the form of [low, high].

FIG. 7C depicts an example of a body structure with a load.

FIG. 7D depicts an example of a differential mode of a single-ended topology circuit.

FIG. 7E depicts an example topology of a current source type sub-circuit.

FIG. 7F depicts an example topology of DC-biasing type sub-circuit.

FIG. 8 is a confusion matrix of the predicted topologies.

FIGS. 9A-9D are graphs showing desired versus determined values of bandwidth, gain, power and noise, respectively, from running the analog circuit generator for different specifications.

FIG. 10 depicts an example operational amplifier design output by the analog circuit generator.

FIG. 11 is a graph showing how power gets smaller with each iteration.

FIGS. 12A-12D show supported filter sub-circuits.

FIG. 13 depicts an example band-pass filter design output by the analog circuit generator.

FIGS. 14A-14C are graphs showing the frequency response of a low-pass filter, a high-pass filter, and a band-pass filter, respectively.

Corresponding reference numerals indicate corresponding parts throughout the several views of the drawings.

### DETAILED DESCRIPTION

Example embodiments will now be described more fully with reference to the accompanying drawings.

Estimating the functionality of circuits and optimizing them are two important areas in automating the design of analog circuits. In estimating the functionality of circuits, the main goal is to find f as a function of circuit parameters, x, to approximate the performance of interest, y. DC bias voltages and size of transistors (W, L) are examples of circuit parameters, and the voltage gain of an operational amplifier (OPAMP) is an example of the performance of interest: y≈f(x).

The goal of analog circuit optimization is to determine the design parameters such that

$$minimize {f}_{1} ( x ) , … {f}_{M} ( x )$$

$$subject to : {c}_{1} ( x ) < 0 , … , {c}_{N} ( x ) < 0 ,$$

where f₁, . . . , f_{M} are the figure of merit of the circuit and c₁, . . . , c_{N} are constraints such as

$${x}_{j} ∈ [ {p}_{j}^{-} , {p}_{j}^{+} ]$$

or bandwidth (BW)>1 GHz.

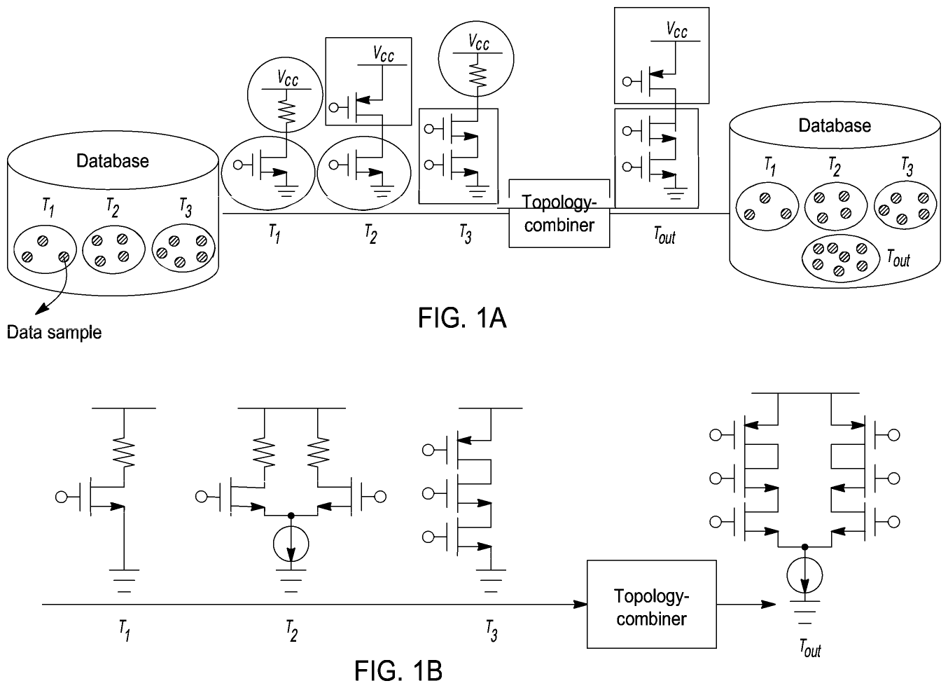

Collecting datasets for simpler topologies is less expensive since they have smaller design spaces. On the other hand, in order to completely cover the design space for complex circuits with many design parameters (e.g. size of transistors), an abundant number of samples are needed. As an example, Tout in FIG. 1B has 21 design parameters i.e. width, length, v_{bias} for 6 transistors and a current source. Therefore, gathering only labeled data by running simulations would be computationally expensive.

FIG. 1A demonstrates the proposed co-learning-based database generation flow. The goal of the topology-combiner is to determine the circuit behavior (i.e. the effect of design parameters on output specifications) of complicated topologies using the simpler ones in order to reduce the size of the required labeled data. The datasets for more basic, simple topologies, e.g. T₁, T₂, T₃, are gathered using simulations. Such datasets contain the value of the specification associated with different circuit design parameters for each topology. Then, the circuit behavior of the more complicated topology (Tₒᵤₜ) is determined using combinations of the simpler ones. For example, in FIG. 1A, Tₒᵤₜ is built by replacing the resistive load of T₃ with the PMOS load of T₂. Moreover, T₁ has the same body and resistive load as T₂ and T₃, respectively. So, intuitively, the behavior of Tₒᵤₜ can be modeled by leveraging the previously gathered T₁, T₂, T₃ datasets information. Then, a large pseudo sample set that covers the design space of Tₒᵤₜ is generated with almost zero cost using such a model (unlabeled data). So, the database is a combination of labeled and unlabeled data. Now that the dataset of Tₒᵤₜ is generated, it can be used to build more complicated topologies. As an example, the output topology in FIG. 1A is used to make a more complicated topology in FIG. 1B.

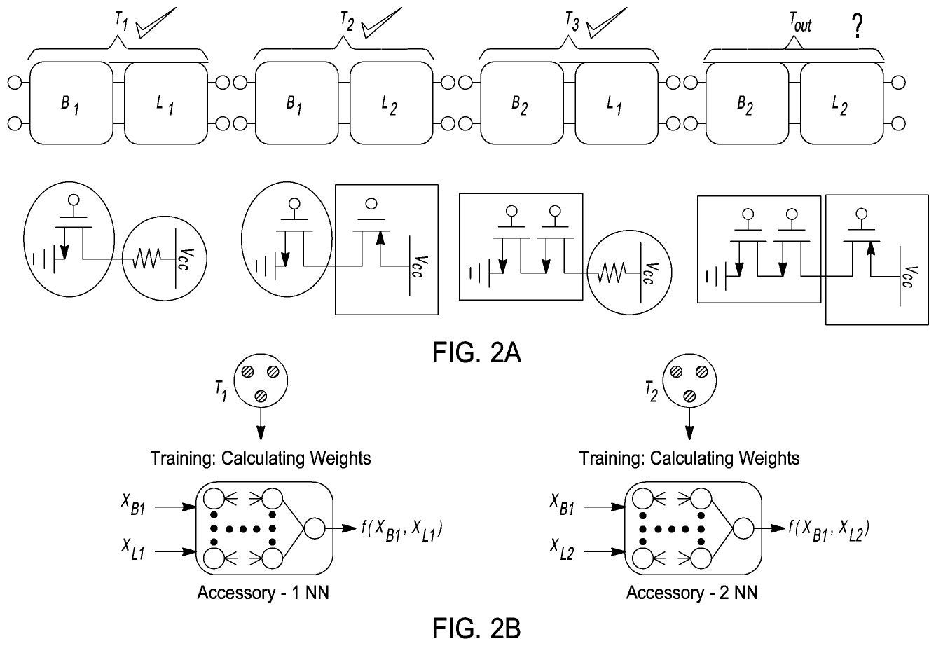

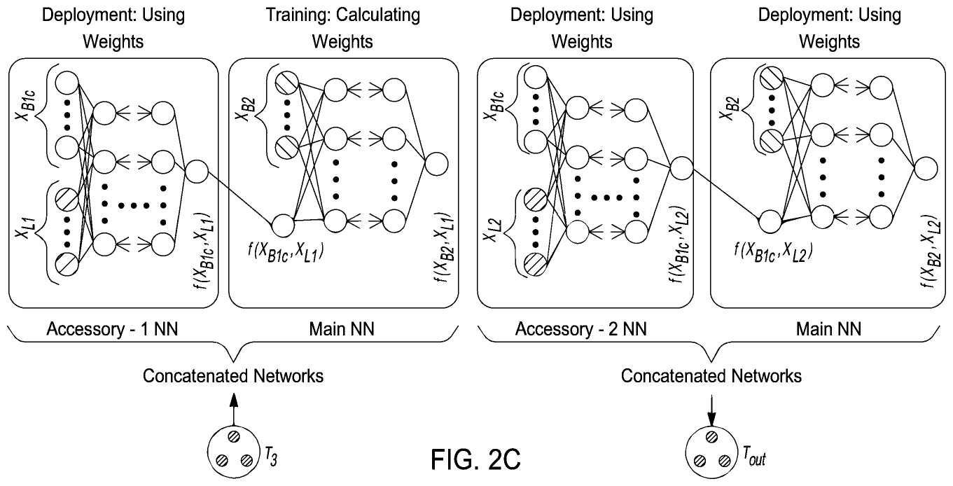

FIG. 2A demonstrates the general structure of three simpler topologies (T₁, T₂ and T₃) that can be combined to determine the circuit behavior of Tₒᵤₜ. Each topology is composed of two parts: B (body) and L (load). T₁ and T₂ have the same body (B₁) and T₁, T₃ have the same load (L₁). Moreover, Tₒᵤₜ has the same body (B₂) and load (L₂) as T₃ and T₂, respectively. The notation of x_{B} and x_{L} is used for showing the design parameters of body and load, respectively, and f(x_{B}, x_{L}) for denoting a circuit specification when the body is B, and load is L. This f can be any of circuit specifications such as gain, bandwidth, etc. The training process needs to be done individually for each circuit specification.

The goal is to determine the mapping from x_{B}_{₂}, x_{L}_{₂}, i.e., the design parameters of Tₒᵤₜ topology, to f(x_{B}_{₂}, x_{L}_{_{Z}}) without having any direct mapping samples. That is, to determine the mapping ξ_{T}_{ₒᵤₜ}:

$${ξ}_{{T}_{o u t}} ( {x}_{{B}_{2}} , {x}_{{L}_{2}} ) ↦ f ( {x}_{{B}_{2}} , {x}_{{L}_{2}} ) \qquad ( 2 )$$

FIGS. 2B and 2C show the neural network implementation for the proposed topology-combiner and how the dataset of each of T₁, T₂, and T₃, is used in the training of such neural networks. The first step is to train the accessory-1 model using the training set of T₁. As it is depicted in FIG. 2B on the left side, inputs are the design parameters of T₁, and the output is the desired specification in T₁, i.e. f(x_{B}_{₁}, x_{L}_{₁}). Similarly, the accessory-2 model is trained by leveraging the T₂ dataset while inputs and outputs are the design parameters and the desired specification of T₂, respectively. The accessory-2 neural network is shown in FIG. 2B on the right side.

Next, the accessory-1 and the main neural networks are concatenated as shown in FIG. 2C on the left side. Note that the accessory-1 neural network is used in the deployment phase now. By giving a fixed, constant x_{B}_{₁} which is denoted with [symbol] the inputs variable of this concatenated network would be x_{B}_{₂} and X_{L}_{₁} which are the design parameters of T₃. As it is shown, the output is the desired specification in T₃, i.e., f(x_{B}_{₂}, x_{L}_{₁}). Since the accessory-1 neural network is already trained, by training this concatenated network, the weights of the main neural network are calculated. In other words, one has:

$${ξ}_{M a i n} : ( {x}_{{B}_{2}} , f ( {x}_{{B}_{{1}_{c}}} , {x}_{{L}_{1}} ) ) ↦ f ( {x}_{{B}_{2}} , {x}_{{L}_{1}} ) \qquad ( 3 )$$

The inputs of the main neural network are x_{B}_{₂}, and

$$f ( {x}_{{B}_{{1}_{c}}} , {x}_{{L}_{1}} )$$

while the output is the desired specification of the topology with B₂ body and L₁ load. Therefore, during the deployment phase of the main neural network by replacing L₁ and L₂ (giving

$$f ( {x}_{{B}_{{1}_{c}}} , {x}_{{L}_{2}} )$$

instead of

$$f ( {x}_{{B}_{{1}_{c}}} , {x}_{{L}_{1}} ) ) ,$$

one has the desired specification of the topology with B₂ body and L₂ load, which is the goal, Tₒᵤₜ. This means one has:

$${ζ}_{Main}^{′} : ( {x}_{{B}_{2}} , f ( {x}_{{B}_{1 c}} , {x}_{{L}_{2}} ) ) ↦ f ( {x}_{{B}_{2}} , {x}_{{L}_{2}} ) \qquad ( 4 )$$

which has been derived by replacing x_{L}_{₁} with x_{L}_{₂} in equation (3). This is perfectly aligned with the goal in equation (2) as if we replace x_{L}_{₂} with the corresponding

$$f ( {x}_{{B}_{1 c}} , {x}_{{L}_{2}} )$$

in equation (2) concludes the same equation as equation (4). So, the last step is to map x_{L}_{_{Z}} to the corresponding f

$$f ( {x}_{{B}_{1 c}} , {x}_{{L}_{2}} )$$

which is achieved by using the trained accessory-2 neural network. So, during the deployment phase of accessory-2 neural network, by giving the [symbol] as the body, the mapping of x_{L}_{_{Z}} to

$$f ( {x}_{{B}_{{1}_{c}}} , {x}_{{L}_{2}} )$$

would be had. This procedure is illustrated in FIG. 2C on the right side. Hence, to determine the behavior of Tₒᵤₜ from its design parameters, first find

$$f ( {x}_{{B}_{{1}_{c}}} , {x}_{{L}_{2}} )$$

leveraging the accessory-2 neural network. Next, feed the result to the main neural network along with the design parameters of B₂.

To give more intuition about the models, it should be noted that the key is to have f(x_{B}_{₁}, x_{L}_{₁}) in the main neural network instead of directly depending on the design parameters of the load. Indeed, f(x_{B}_{₁}, x_{L}_{₁}) abstracts the “effect” of a load in a topology with the B₁ body as single input for the main neural network. This is the reason that we are able to replace L₁ with L₂ in the deployment phase of the main neural network. Moreover, the other inputs of the main neural network are the design parameters of B₂ which is the body of Tₒᵤₜ too so, it works exactly as desired.

Using the database presented above, a fully-automated analog circuit generator framework, AnGeL, is presented. As it was mentioned earlier, AnGeL divides the overall circuit into multiple sub-circuits and analyzes each individually. This results in dealing with smaller circuits and hence, requiring a smaller training set size while keeping the same accuracy in comparison with analyzing the overall circuit. The other advantages of dividing the circuit are finding global and local optimum points faster since design spaces of sub-circuits are smaller, faster runtime due to analyzing sub-circuits in parallel, and supporting many topologies while only a few of them are used in the training set.

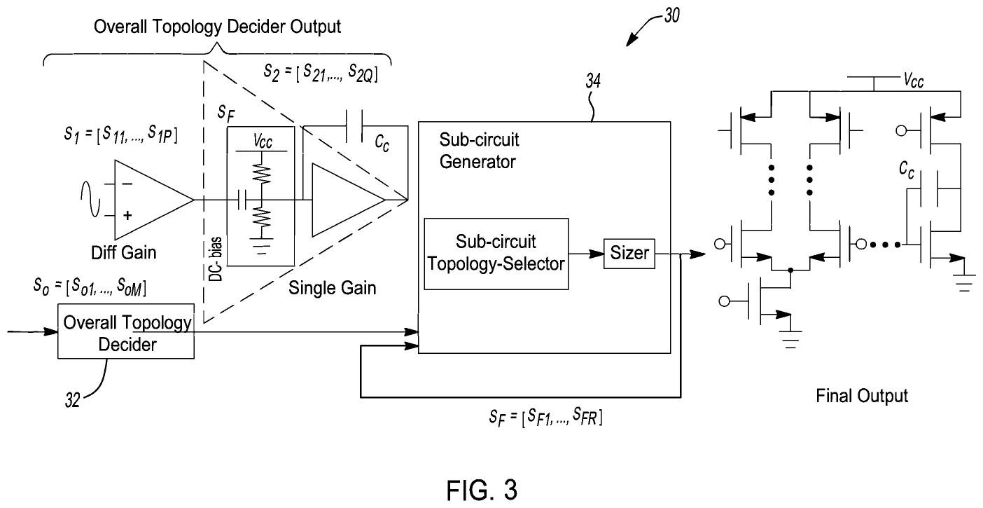

FIG. 3 shows a high-level platform architecture of the proposed circuit design flow of the fully-automated analog circuit generator 30. The analog circuit generator 30 is comprised of an overall topology decider 32 and a sub-circuit generator 34. The overall topology decider 32 is configured to receive a desired specification for an analog circuit. The desired specifications, i.e. Sₒ=[S_{O1}, . . . , S_{oM}] are given to the overall topology decider module 32. Here, assume the given specifications are all in equality format e.g. S_{O1}=C₁, S_{O2}=C₂, . . . . The goal of the analog circuit generator 30 is to design a circuit at the transistor level so that its output specifications are as close as possible to the given ones. Transforming constraints in inequality format e.g. S_{O1}>C₁, S_{O2}<C₂, . . . along with objective functions e.g. minimize S_{oM} are explained below.

The overall topology decider module 32 determines the high-level topology of the analog circuit using one or more machine learning algorithms, where the topology for the analog circuit specifies two or more sub-circuits for constructing the analog circuit and how the two or more sub-circuits are connected together. That is, the overall topology decider module 32 determines the number of stages, type of each sub-circuit (e.g. gain block, DC-biasing), how the sub-circuits are connected to each other (e.g. having feedback, being in parallel or series), and having single-ended or differential input/output ports for sub-circuits. Furthermore, the overall topology decider module 32 determines the specifications for each sub-circuit. The determined specifications for each sub-circuit are passed to the sub-circuit generator module 34 to build a circuit at the transistor level.

The sub-circuit generator 34 is configured to receive the determined specification for an analog circuit and the topology for the analog circuit from the overall topology decider module 32. The sub-circuit generator 34 in turn outputs parameter values for each sub-circuit component comprising each of the two or more sub-circuits using a second machine learning algorithm, where the second machine learning algorithm differs from the machine learning algorithms used by the topology decider 32. The machine learning algorithm used by the topology decider may be one of a random forest, a support vector machine or a neural network; whereas, the second machine learning algorithm is a neural network to determine the design parameters of sub-circuits. These algorithms are merely illustrative and other types of algorithms fall within the broader aspects of this disclosure.

The feedback loop around the sub-circuit generator module 34 shows that the specifications of some sub-circuits (i.e. SF) are determined by the bigger sub-circuits that they are part of. For instance, the specifications of the DC-bias sub-circuit cannot be determined before determining the input DC voltage of the following gain stage. In this regard, AnGeL 30 hierarchically determines the specifications of each sub-circuit regarding the specifications of the parent circuit. This hierarchical approach and circuit division enables AnGeL to design circuits with many design parameters (˜40) in a short time and with high accuracy. For example, a band-pass active filter consists of low-pass and high-pass filters that each may include a two-stage OPAMP. All these sub-circuits are designed in a hierarchical approach and in parallel with each other.

Using the topology decider module 32 and the sub-circuit generator 34, the curse of dimensionality is avoided. The reason is that one is able to determine the behavior of complicated topologies that require more training sets (by leveraging simpler topologies with almost zero cost) and efficiently break down multi-stage circuits into multiple single stages. However, the nonideality of the topology combiner may slightly increase inaccuracy in the whole design process. It should be noted that the topology combiner has a very high accuracy, but this slight nonideality is in the trade-off with the curse of dimensionality. For a better cost comparison between AnGeL 30 and the conventional approaches, denote the number of design parameters in two different sub-circuits with n₁ and n₂, respectively. Assuming take k samples for each parameter, the cost of AnGeL for analyzing a two-stage circuit with those two sub-circuits is

$${n}_{1}^{k} + {n}_{2}^{k} ,$$

considering only the effect of breaking down multi-stage circuits into multiple single stages. However, this cost for the conventional approach is (n₁+n₂)^{k}. As summarized in Table I below, the cost of AnGeL 30 is significantly lower than the conventional approaches for different typical n₁, n₂, and k values.

The main goal of the overall topology decider module 32 is to determine the high-level topology of the circuit and break down the overall circuit specifications into usable specifications for sub-circuits. Determining the sub-circuit specifications via overall specifications is challenging. The assigned sub-circuits' specifications need to meet the overall specification when they are assembled together as the associated high-level topology. This requires a proper training set that teaches the module how to assign sub-circuits' specifications such that the net impact of them in the associated high-level topology meets the overall specification. Furthermore, there are multiple ways for breaking down each overall specification, but many of them are not feasible for sub-circuits considering other specifications. For instance, assigning a large gain and bandwidth to a sub-circuit may not be feasible simultaneously. Therefore, a large, proper training set is needed for learning all these relationships.

To overcome the aforementioned challenges, two main models are implemented: 1) net-specification-calculator model for calculating the net impact of different sub-circuits' specifications at the module-level on the overall circuit; and 2) overall-specification-breaker model which uses a large dataset generated by the net-specification-calculator model for properly breaking down the overall specifications into sub-circuits specifications as well as determining the high-level topology. The overall-specification-breaker model consists of two neural networks models: A) a classifier for selecting the most suitable high-level circuit topology; and B) a regressor for determining the target specifications of each sub-circuit.

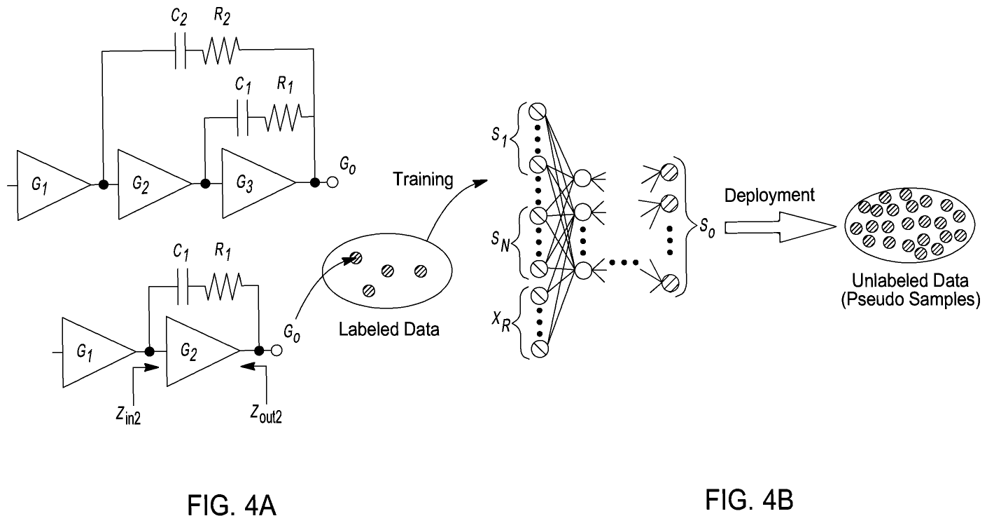

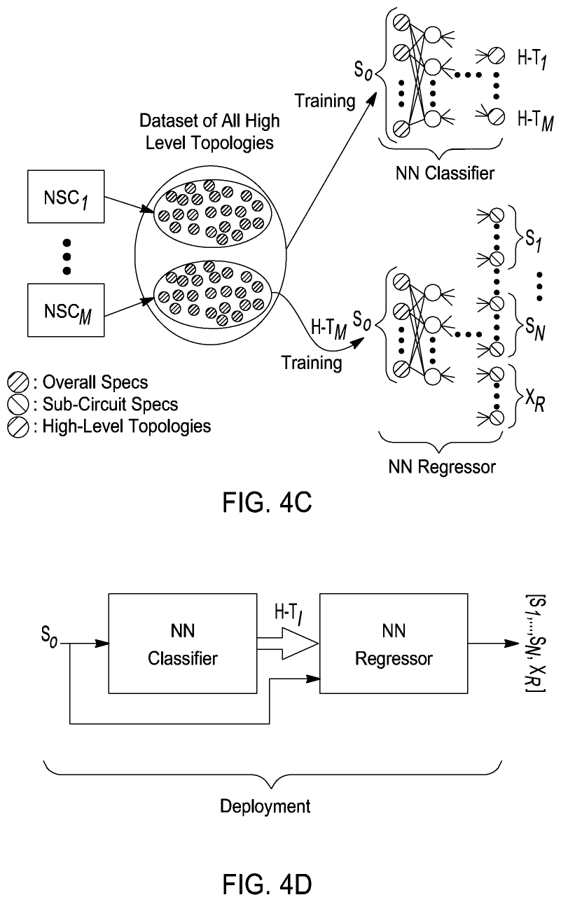

FIG. 4A illustrates two examples of high-level circuit topologies. According to FIG. 4, the overall specifications (Sₒ) is a function of sub-circuits' specifications (S₁, . . . , S_{N}), and other circuit's design parameters that are not included in any sub-circuits (X_{R}). For example, the overall DC gain (Gₒ) is a function of sub-circuits' DC gain (G₁, G₂, G₃) and input/output impedance of each sub-circuit (Zᵢₙ, Zₒᵤₜ). It should be mentioned that each of Sᵢ∀i ∈{1, . . . , N}} is a vector of specifications. So, to calculate the overall gain, the input/output resistance of each sub-circuit is given in addition to their DC gains, as an example. R₁, R₂, C₁, C₂ are examples of design parameters that are not included in any sub-circuits (i.e. X_{R}) in FIG. 4A that are used for calculating phase margin in amplifiers for instance. By taking the input/output impedance of sub-circuits as well as X_{R} into account, the loading effects are properly considered in the model.

FIG. 4B depicts the neural network implementation of the net-specification-calculator model. During training, a labeled dataset is used for learning the net impact of different sub-circuits specifications at the module-level. A separate regression neural network model is used for learning such net impacts on each high-level topology. Once the net-specification-calculator models are trained, in the deployment phase, a large set of different unlabeled data (S₁, . . . , S_{N}, X_{R}) are fed to them to generate pseudo samples ({S₁, . . . , S_{N}, X_{R}}, Sₒ). Indeed, the output is the overall circuit specifications, Sₒ, associated with each unlabeled input in different high-level topologies. Generating such a large set is with almost zero cost since the net specification calculator is already trained. This large unlabeled dataset is used for training another model, overall specification breaker. This unlabeled dataset addresses both challenges of being large and being able to teach how to assign sub-circuits' specifications that the net impact of them meet the overall specifications. The reason is that for all of the large dataset samples({S₁, . . . , S_{N}, X_{R}}, Sₒ), the overall specification equals the net impact of sub-circuits' specifications by definition.

The overall specification breaker learns how to properly break down the overall specifications into sub-circuits' specifications as well as how to determine the high-level topology. FIG. 4C demonstrates the overall-specification breaker-model in training phase. During training, using a dataset of all high-level topologies populated by the net-specification-calculator model, an NN classifier learns how to select the most suitable high-level circuit topology between available candidates regarding the overall specifications. Moreover, a separate NN regressor is implemented to break down the overall specifications into sub-circuits' specifications for each high-level topology using the large provided training set. This large training set works as a lookup table for the regressor model. As shown in FIG. 4D, during deployment, first, the classifier selects the high-level topology. Then, based on such a high-level topology, the regressor model breaks down the overall specifications into sub-circuits' specifications. It should be mentioned that with increasing the number sub-circuits or elements that are not included in sub-circuits (X_{R}), both the net-specification-calculator and overall-specification-breaker models become more complicated. However, this approach in such cases still outperforms the conventional methods which do not have the overall topology decider module as the conventional models become much more complicated than ours. To summarize, these are the overall topology decider steps and models. First, the net-specification-calculator model calculates the net impact of different sub-circuits' specifications at the module-level on the overall circuit. In the deployment phase, for each overall circuit topology, the net-specification-calculator model generates a large set of overall specs by getting sub-circuit specs as inputs. Using the generated datasets by the net-specification-calculator models as the training set, the overall-specification-breaker model breaks down the overall specifications into sub-circuits specifications and determines the high-level topology as well. The overall-specification-breaker model consists of two neural network models: 1) a classifier for selecting the most suitable high-level circuit topology between available candidates, and 2) a regressor for determining the target specifications of each sub-circuit. With taking input and output impedances of sub-circuits as well as X_{R} into account, the loading effects are properly considered in the model.

In order to decide the transistor level topology for each sub-circuit, the target specifications of the sub-circuit are input to a classifier model, and it selects the most suitable topology. There are multiple candidates in the database where the classifier decides which one is the most appropriate for the given specifications. To this end, three different classification models, i.e., random forest, Support Vector Machine (SVM), and neural network classifier are analyzed. Moreover, the SVM is analyzed using four different kernels: linear, polynomial, sigmoid, and Radial Basis Function (RBF). During the training, the circuit parameters and the associated topology are given as input and output, respectively.

More complicated topologies in the database have more instances since their design spaces are larger, which causes imbalanced data. To solve this, a subset of the database is considered for training that has the same number of samples for all topologies. This method is called down-sampling.

When the topology of sub-circuits is decided, a proper sizing is needed to determine the design parameters value e.g. size of transistors and value of voltages. The goal of sizing is to determine the design parameters such that:

$$minimize {\sum }_{i} {ω}_{i} \vert \frac{{S}_{s i} - {S}_{s i}^{*}}{{S}_{s i}} \vert , \qquad ( 5 )$$

$$subject to : \vert \frac{{S}_{s i} - {S}_{s i}^{*}}{{S}_{s i}} \vert < {ε}_{i} ,$$

where Sₛᵢ are the desired specifications and Sₛᵢ* are the determined specifications by the sub-circuit sizing module. ωᵢ are the weights that are used to prioritize specifications that are more important for users

$$\vert \frac{{S}_{s i} - {S}_{s i}^{*}}{{S}_{s i}} \vert < {ε}_{i}$$

in equation (5), ensures each output specification is as close as possible to the associated desired specification.

In order to minimize equation (5), global and local optimization engines are implemented. For this purpose, first, train a separate regression NN for each topology to estimate the functionality of sub-circuits when the circuit parameters are given. These neural networks work as a fast circuit simulator instead of invoking time-consuming SPICE. Apply the local optimization on the multiple designs that have resulted in the minimum of equation (5) in the global phase. The final result is the best one among these local optimums.

At the global optimization phase, find the closest designs to the desired specifications by implementing a grid search that covers the design space. To this end, apply the NN functionality estimator to each set of parameters in the design space. Then, the estimated result specifications are compared with the desired ones. Note that the design spaces of sub-circuits are relatively small since they have only a few design parameters. Moreover, once the neural network model is trained, it is able to execute a large input set in a very short time. So, the global optimization phase takes only a few seconds.

Particle Swarm Optimization (PSO) is implemented as the local optimization engine. In PSO, if the position of the i^{th} particle at iteration k is denoted as

$${X}_{i}^{k} ,$$

one has:

$${X}_{i}^{k + 1} = {X}_{i}^{k} + {V}_{i}^{k + 1} , \qquad ( 6 )$$

where Vᵢ^{k} is the velocity of particle ith at iteration k. The velocity is updated as:

$${V}_{i}^{k + 1} = ω {V}_{i}^{k} + {b}_{1} {r}_{1} ( {pbest}_{i} - {X}_{i}^{k} ) + {b}_{2} {r}_{2} ( gbest - {X}_{i}^{k} ) , \qquad ( 7 )$$

where r₁, r₂ are random numbers and ω, b₁, b₂ are constant hyperparameters. Furthermore, pbestᵢ denotes the position that gives the best-explored value for the ith particle while gbest is the best-explored value by all the particles. In order to accelerate the local optimization process, use the trained neural network to estimate the functionality of sub-circuits instead of invoking SPICE.

Multiple algorithms are tested as the global and local optimization engines. Using any of the simulation-based algorithms as the global engine makes the process slow as it requires many iterations (˜300-1500), and such iterations happen sequentially. Moreover, for the local engine, one of the advantages of PSO over other optimization algorithms (e.g. Bayesian Optimization (BO), Simulated Annealing (SA), etc.) is that PSO processes multiple particles at each iteration which causes much faster design space exploration. Especially because the NN regression model is used as the circuit simulator, this process is very fast. Only 5-10 iterations in the local phase are used using PSO.

As it was mentioned earlier, AnGeL is designed to get the desired overall specifications, Sₒ=[Sₒ₁, . . . , S_{oM}] as an input while all constraints are defined in equality format e.g. S₀ᵢ=C₁, S₀₂=C₂, . . . . The goal of AnGeL is to implement a circuit that its output specifications are as close as possible to the given ones. However, it is common to have constraints in inequality format along with an objective function, as shown in Equation (8).

$$minimize {S}_{oM} \qquad ( 8 )$$

$$subject to : \{ \begin{matrix}{S}_{O 1} > {C}_{1} \\ {S}_{O 2} < {C}_{2} \\ ⋮ \\ {S}_{OM - 1} > {C}_{M - 1}\end{matrix}$$

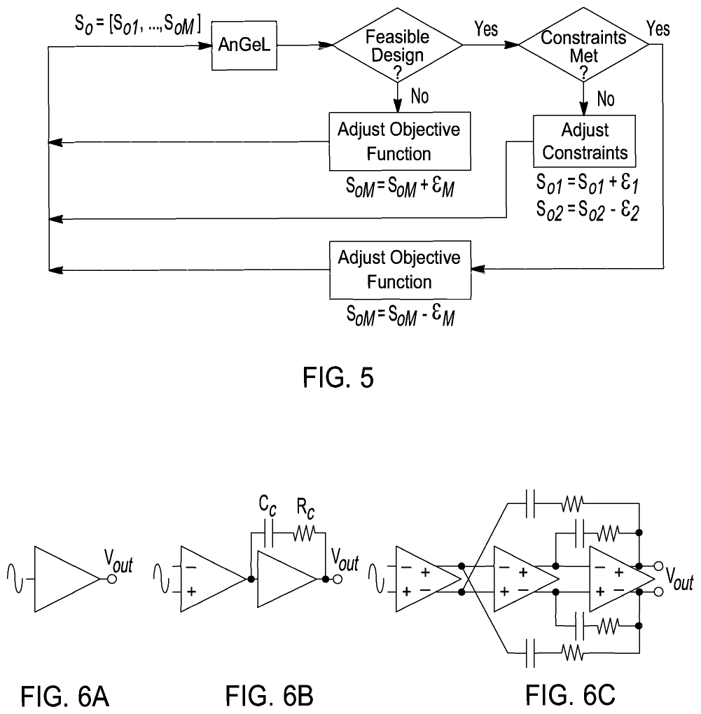

The algorithm depicted in FIG. 5 is used to solve Equation (8) using AnGeL. At each iteration, Sₒ=[Sₒ₁, . . . , S_{oM}], is given to AnGeL as the overall specifications where the values of Sₒ₁, . . . , S_{oM} are determined by the algorithm. The idea of binary search is used for optimizing the objective function, S_{oM}, i.e.

$${C}_{M} = \frac{{S}_{o M}^{h i g h} + {S}_{o M}^{s l o w}}{2} .$$

If AnGeL is able to design a circuit with the given specifications, it means the design is feasible and then check if the constraints are met as the next step. Otherwise, this means the chosen value for the objective function is too small. Therefore, a bigger value i.e. S_{oM} MS_{oM}+∈_{M} will be targeted for the next iteration where ∈_{M}>0.

To check if the constraints are met, the output of AnGeL is simulated either by SPICE or by AnGeL's functional estimator models. If the constraints are met, the target value of the objective function will be reduced i.e. S_{oM}=S_{oM}−∈_{M}. Otherwise, the constraints that are not met would be adjusted. For this purpose, target specifications are increased (if Sₒᵢ>Cᵢ) or decreased (if Sₒᵢ<Cᵢ) to give more margin for constraint satisfaction in the next iteration. For example, in equation (8), if Sₒ₁ and Sₒ₂ are not met, Sₒ₁=Sₒ₁+∈₁ and Sₒ₂=Sₒ₂−∈₂ in the next iteration. The maximum number of iterations for adjusting the constraints and the objective function, as well as the values of ∈ᵢ>0 ∀i ∈{1, . . . , M}∈ᵢ> are given by users.

For illustration purposes, the implementation of one-stage, two-stage, and three-stage operational amplifiers as well as filters using AnGeL is evaluated. The performance of the synthesized circuits by AnGeL is validated by SPICE simulations. The design parameters include all transistor sizes (W, L, V_{bias}) as well as capacitor and resistor values. All the SPICE simulations are in the 55 nm technology node and based on the pre-layout parasitic analysis. Going from pre-layout parasitic to post-layout can be done using transfer learning, it should be noted that in the post-layout, the value of this disclosure would be even shown more as more time would be saved using this method in comparison to the conventional approaches. Also, all the neural network models are built using the TensorFlow platform with the Adam optimizer. The learning rate is set to 0.001 and RELU is used as the activation function for all hidden layers. In order to avoid overfitting, the idea of early stopping with the patience parameter of 150 is implemented. For this purpose, 10% of the data are used for validation during the training phase. In order to validate the results properly, a random separate test set with the size of 10% of the training set is used. Moreover, Scikit-learn is used for the training and testing of all random forest and SVM models. All the training and testing of our models are run on a server with an NVIDIA GA102 GPU.

For OPAMP design, three overall topologies are assumed in the database as seen in FIGS. 6A-6C. Two instances of inputs and outputs of the overall topology decider are summarized in the table below.

| | | | Output | | | | | | | | |
|---|---|---|---|---|---|---|---|---|---|---|---|
| Input (Sₒ) | | | Topol- | | | | | | | | |
| G(Sₒ₁) | P(Sₒ₂) | PM(Sₒ₃) | ogy | G₁ | P₁ | G₂ | P₂ | G₃ | P₃ | C_{c1} | C_{c2} |
| 40 dB | 5 mW | 60° | 2 | 20 dB | 3 mW | 20 dB | 2 mW | — | — | 0.2 nF | — |
| 60 dB | 9 mW | 60° | 3 | 20 dB | 4 mW | 20 dB | 3 mW | 20 dB | 2 mW | 0.2 nF | 0.1 nF |

Here, G and P are the overall gain and power, respectively. G₁, G₂, G₃, are the gain of first, second, and third subcircuits, respectively. Similarly, P₁, P₂, P₃, are the power of first, second, and third subcircuits, respectively.

The overall topology determined by the overall topology decider module, along with the specifications of each sub-circuits are given as inputs to the sub-circuit generator. Assuming the highlighted first entry from the table able services as the input to the sub-circuit generator, the inputs and outputs of the sub-circuit generator are as summarized in table below.

TABLE II
Input/output structure of the sub-circuit generator module for OPAMPs

| Input | | | | | | | | | | | |
|---|---|---|---|---|---|---|---|---|---|---|---|
| Topol- | Sub- | | | Output | | | | | | | |
| ogy | circuit | Gain | Power | W₁/L₁ | W₂/L₂ | W₃/L₃ | W₄/L₄ | W₅/L₅ | W₆/L₆ | W₇/L₇ | V_{b} |
| 2 | 1 | 20 dB | 3 mW | 40/0.06 | 40/0.06 | 15/0.06 | 15/0.06 | 13/0.06 | — | — | 0.6 V |
| | 2 | 20 dB | 2 mW | — | — | — | — | — | 35/0.12 | 30/0.06 | |

Input

| Topol- | Sub- | | | Output | | | | |
|---|---|---|---|---|---|---|---|---|
| ogy | circuit | Gain | Power | V_{b5} | R₁ | R₂ | C_{b} | V_{b7} |
| 2 | 1 | 20 dB | 3 mW | 0.5 V | — | — | — | — |
| | 2 | 20 dB | 2 mW | — | 40 kΩ | 40 kΩ | 1 uF | 0.7 V |

Here, W and L are width and length of transistor channels.

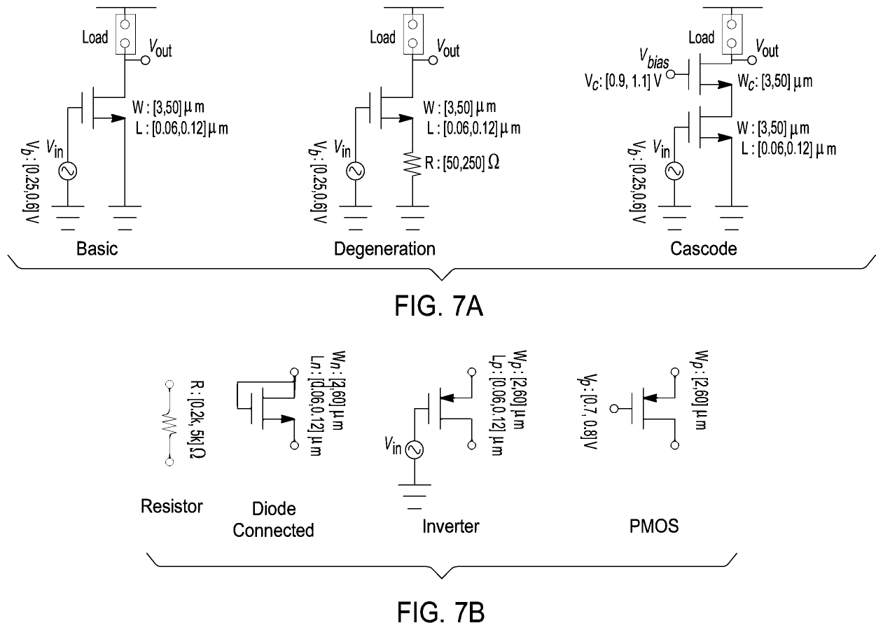

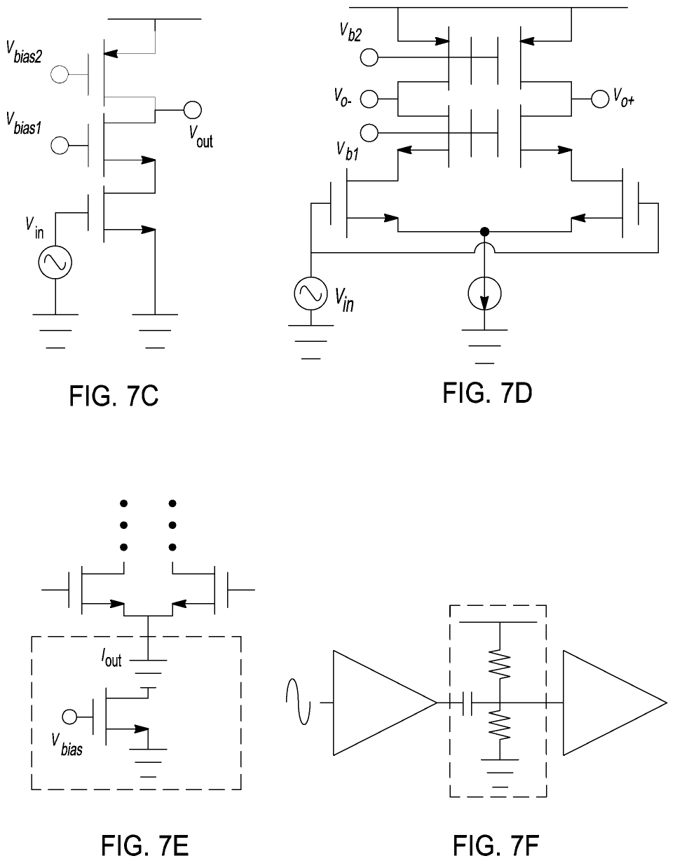

The supported sub-circuits (i.e. gain block, current source, and DC-biasing) are shown in FIG. 7. For the gain block sub-circuits, all combinations of three body structures with four loads that are shown in FIGS. 7A, and 7B are supported in the single-ended and differential modes. So, in total, 3×4×2=24 different topologies are supported for the gain block sub-circuits. The range of supported design parameters is written next to each in the form of [low, high] in FIGS. 7A and 7B. The specifications for such DC-biasing and current source sub-circuits are determined by the associated gain stage through the feedback loop that is explained in FIG. 3. The supporting specifications statistics for each circuit type are summarized in Table II.

From twelve supporting single-ended gain block sub-circuits in FIGS. 7A and 7B, the topology-combiner model is used for generating the dataset of six of them i.e. the degeneration and Cascode body structures with all loads except the resistor. Moreover, the topology-combiner model generates the datasets of all twelve differential gain stages except the one with the basic body and resistive load. The main and accessory neural networks in the topology combiner model have three hidden layers with 64 nodes. As indicated in Table Ill, for single-ended and differential gain blocks, the generated data are 2.23× and 51.74× more than the labeled data (simulations), respectively. Assuming each SPICE run takes 4 s, that results in a time savings of more than 44 h. The reason that the required number of labeled data for complicated differential sub-circuits is less than single-ended, is that they are generated by combining single-ended topologies. This shows the beauty of the topology combiner model that when topologies get more complicated, less labeled data is needed to process them.

Testing on more than 650 instances from 17 different topologies for 5 specifications shows the topology combiner has an average Mean Absolute Percentage Error (MAPE) of 0.047. MAPE is calculated as

$${\sum }_{i = 1}^{n} \frac{1}{n} \vert \frac{{y}_{ti} - {y}_{p i}}{{y}_{ti}} \vert ,$$

where yₜᵢ and yₚᵢ are the i^{th} true and predicted instance, respectively and n is the total number of instances. Table IV lists the mean absolute percentage error of each specification.

The training data for all of the following evaluations are gathered from both labeled and unlabeled generated data. In order to validate the results properly, a random separate test set is built by SPICE runs.

In total, 14,000 labeled samples are used for the training of the net specification calculator models in two high-level topologies shown in FIGS. 6B and 6C. 250,000 pseudo samples of two-stage, and three-stage OPAMP specifications are generated and fed to the specification breaker model.

The net specification calculator and specification breaker models enable one to support 24×24=576 two-stage OPAMP topologies as 24 topologies are supported for each stage. Moreover, 12×12×12=1,728 three-stage OPAMP topologies are supported (i.e., only support differential gain for three-stage OPAMPs). This means with only having datasets of 7 topologies from labeled data, 2,328 different one-stage, two-stage, and three-stage OPAMP topologies are supported. The number of design parameters in such OPAMPs varies between 4-31.

The required number of labeled training data of AnGeL is compared with state-of-the-art work. For example, Hassan-pourghadi et al. in “Circuit connectivity inspired neural network for analog mixed-signal functional modeling” in Proc. 58^{th} ACM/IEEE Design Automation Conference, December 2021 describes dividing the circuit into sub-circuits and implementing a Circuit-Connectivity-Inspired ANN (CCI-NN) model. However, they use neither the idea of the topology combiner nor the net specification calculator model. In order to measure the usefulness of the net specification calculator model in multistage circuits, we also analyze when CCI-NN is integrated with the topology combiner. For this purpose, test all works on 3,500 instances while all have the same average MAPE of 0.045 in estimating the functionality of circuits. AnGeL that integrates both the topology combiner and net specification calculator model requires 22,500 labeled data in total which means it needs around 5.5 labeled data per topology for covering 1728 three-stage OPAMP topologies. Using the net specification calculator model, one estimates the functionality of multistage OPAMPs with different topologies without requiring a separate dataset for each topology. As summarized in Table V below, for three-stage OPAMPs, CCI-NN and CCI-NN integrated with the topology combiner need 1,090× and 200× more labeled data than AnGeL, respectively.

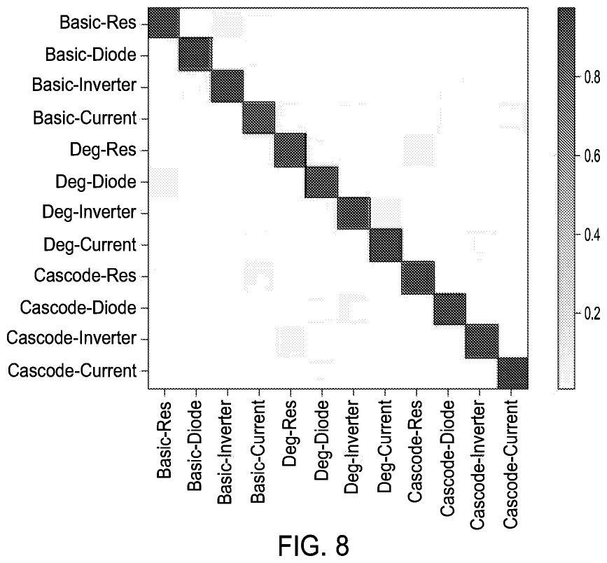

Random forest, SVM (linear, polynomial, sigmoid, and RBF kernels), as well as neural network classifier models, are analyzed for the topology-selector. For the gain block sub-circuits, there are 40,000 and 4,000 samples for the training and test sets, respectively. An evaluation shows the neural network with four layers and 128 nodes at each layer gives an accuracy of 92.9% which is the highest among the compared methods. This neural network is used as the topology-selector model. FIG. 8 shows the confusion matrix of the predicted topologies using this model. It should be noted that even if a topology is not classified correctly, it does not mean that AnGeL cannot meet the specifications with that topology. This is because there may be more than one topology that can achieve the same specifications.

As it was mentioned earlier, neural networks and PSO are used as the global and local optimization engines, respectively. Table VI below summarizes the runtime and MAPE as well as the parameters of different methods when tested on more than 30 samples. This approach results in the minimum runtime while it has a reasonable MAPE of 0.059. In fact, the runtime of the approach is 2.93×-228,400× faster than other methods while it has better or comparable MAPE. The neural network for the sub-circuit sizing model has three hidden layers with 64 nodes. For a better comparison, training time is taken into account too, which is 34,000 s assuming each SPICE run takes 4 s on average for generating each of the 8,500 labeled data. When the estimator is the neural network, it means the same training set as ours is used for other approaches (i.e. when both global and local engines are PSO, SA, and BO). So, this approach still outperforms them. However, considering both training and deployment time on a single run when SPICE is used as the estimator, BO as both global and local engines is faster than the proposed method. In such conditions based on Table VI, even though our MAPE is better, BO (which has the lowest SPICE runtime) takes 26,912 s while the proposed method takes 34,034 s. In fact, the NN estimator shows its actual advantage when the tool is used multiple times for generating circuits in the inference mode. For instance, if run the tool 10 times, this approach takes 34,341.5 s while BO takes 269,120 s which means 65.21 hours are saved during these runs using the proposed method.

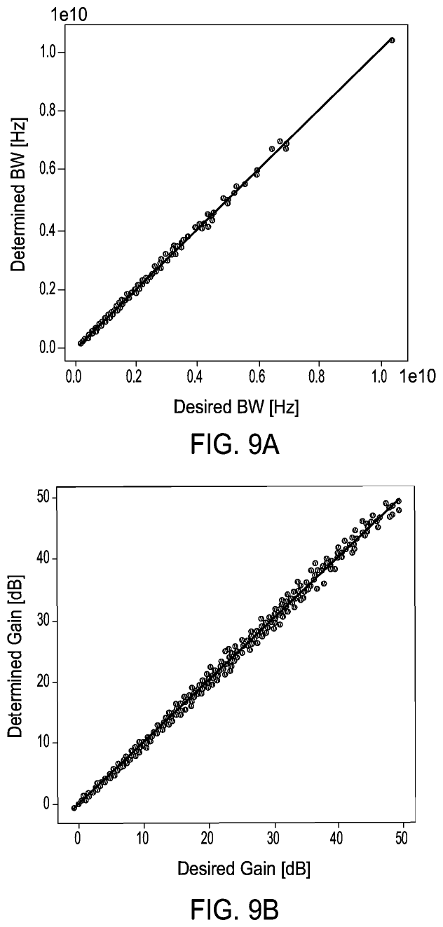

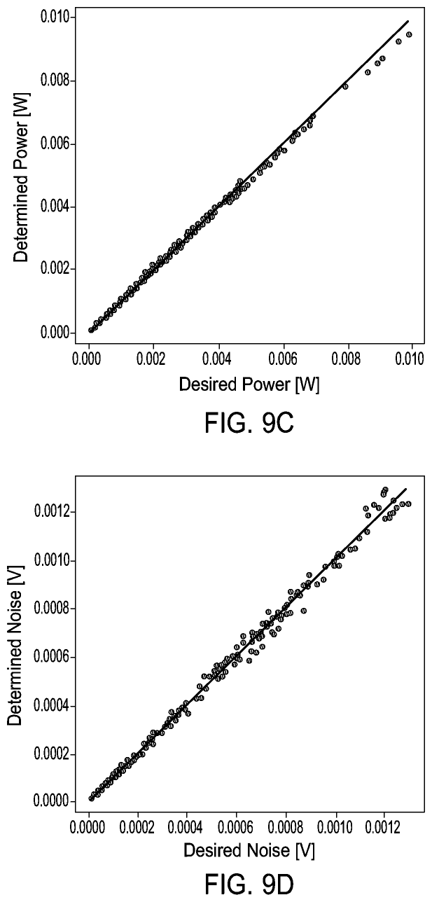

The entire AnGeL platform, from selecting the topology to sizing, is tested on more than 1,200 samples including one-stage, two-stage, and three-stage OPAMPs. The samples cover Table II specifications. The circuits that are generated by AnGeL for the given specifications are simulated to evaluate the performance. FIG. 9 shows the desired vs determined values for different specifications. An average MAPE of 0.027 is achieved in total.

An example of these 1,200 desired specifications is as follows:

$$minimize power subject to : \{ \begin{matrix}BW > 15 MHz , Gain > 48 dB . \\ GM > O dB , Noise < 0.25 mV \\ PM > 60 ° , Swing > 70 mV\end{matrix} . \qquad ( 9 )$$

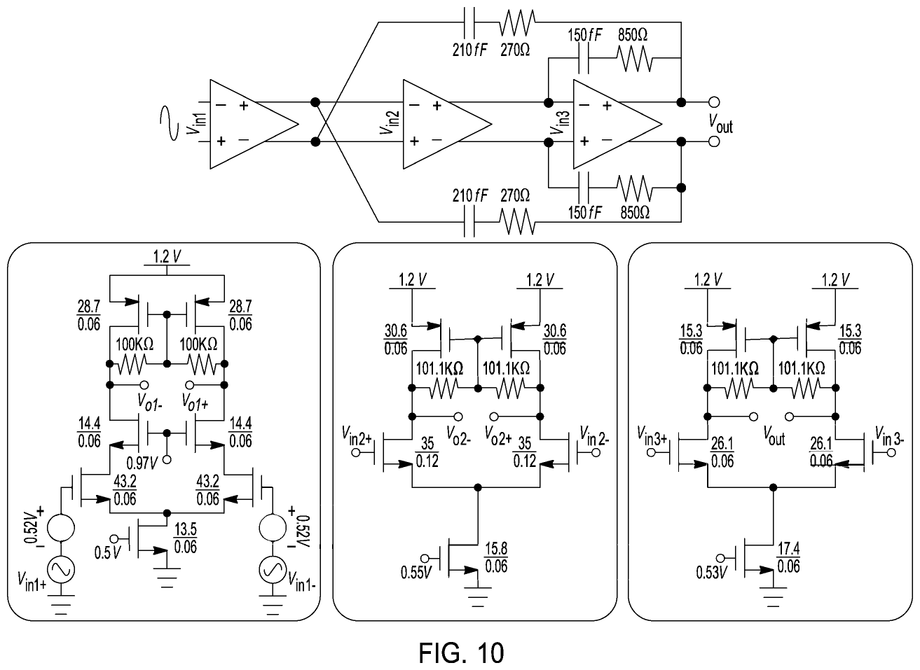

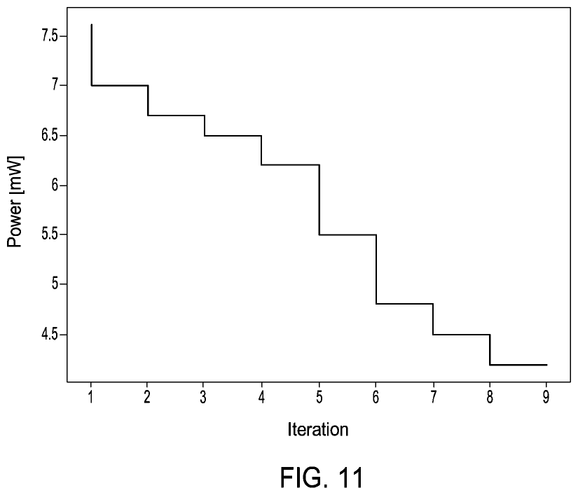

FIG. 10 demonstrates the generated circuit by AnGeL in one of the iterations for minimizing the power while the constraints are satisfied. There are 27 design parameters in this design. Table VII below summarizes the desired and determined specifications of each stage as well as the overall circuit performance. Each stage desired specifications are generated by the overall topology decider module. The overall circuit desired specifications are determined by the constraint transformer module (FIG. 5). FIG. 11 shows how the power gets smaller at each iteration. 4.2 mW is the minimum achieved power while all constraints are met.

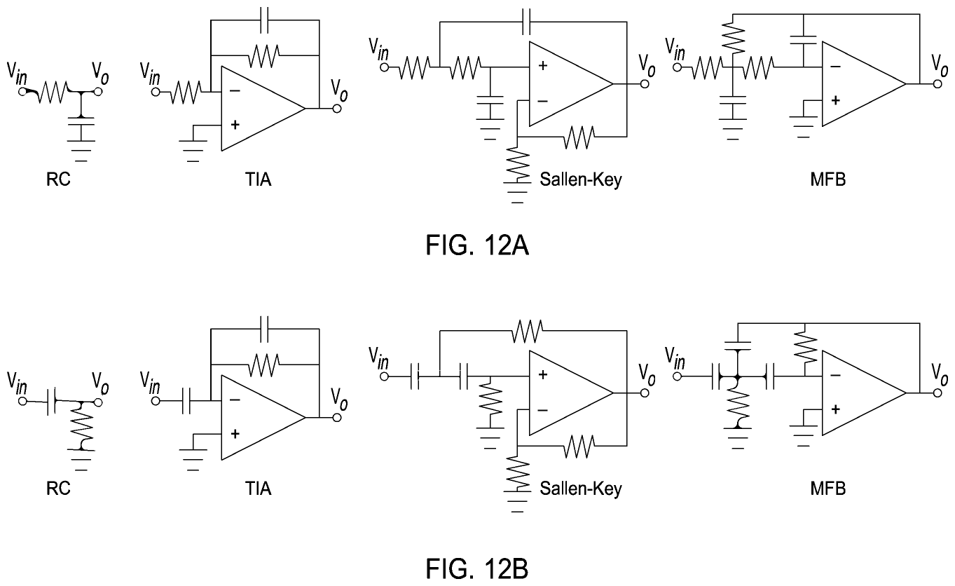

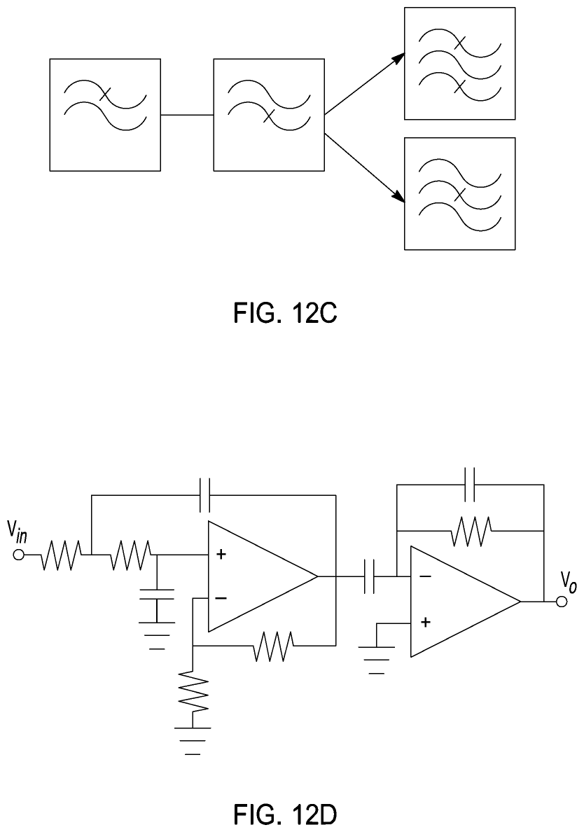

In general, there are two types of filters: passive and active. Passive filters use only passive elements (e.g. resistors, inductors, and capacitors), while active filters use active components, such as OPAMPs. FIGS. 12A-12D show the supported filter sub-circuits. There are 4 topologies for each of Low-Pass (LP) and High-Pass (HP) filters. Moreover, band-pass and band-stop filters are achievable by cascading LP and HP filters as illustrated in FIG. 12C. So, there are 4×4=16 different topologies for each of band-pass and band-stop filters which leads to support 40 filters in total. The specifications for the OPAMP in active filters are determined by the associated filter stage through the feedback loop that is explained in FIG. 3. Taking one-stage and two-stage OPAMP topologies into account results in supporting more than 6,400,000 topologies. The number of design parameters varies between 2-42. The supporting specifications statistics for filters are listed in Table VIII below.

In total, 8,500 simulations are performed as the labeled dataset for all filters assuming a non-ideal OPAMP model is used in active filters. A non-ideal OPAMP model means an OPAMP with limited gain and bandwidth whose characteristic is modeled however, it is not made by circuit elements, e.g., transistors. Moreover, 32,000 unlabeled data are generated using the topology-combiner model. The labeled data is used for generating the database of LP and HP filters. The datasets of band-pass and band-stop filters are generated by the topology-combiner model (except when RC is used in both stages of the band-pass or band-stop filters). Testing on more than 800 instances from 32 different topologies for 5 specifications shows the topology combiner has an average MAPE of 0.04.

Similar to OPAMPs, the required number of labeled training data of AnGeL is compared with the state-of-the-art works while all approaches achieve an average MAPE of 0.06 in estimating the functionality of filters testing on more than 1,200 samples. Also, analyze when the idea of the hierarchical design is used in CCI-NN meaning the specifications of OPAMPs in active filters are determined based on the specifications of the filter. This hierarchical approach allows for smaller training set as it breaks down the circuit. As it is summarized in Table IX below, when actual transistor-level OPAMPs are used, hierarchical CCI-NN requires significantly less data than the normal CCI-NN. Moreover, AnGeL requires 7.9× less labeled data in comparison with the hierarchical CCI-NN.

For the sub-circuit topology selector, there are 35,000 and 3,500 samples for the training and test sets, respectively. Some specifications of band-pass/band-stop filters are different from LP/HP filters so, they are analyzed separately. The accuracy of different models for topology classification is summarized in Table X below.

Similar to OPAMPs, the entire AnGeL platform is tested on 1,200 samples which cover Table VIII below. Actual transistor-level OPAMPs that are created by AnGeL as described above are used in all active filter samples. It should be noted that more than 35,000 are used for the training of the sub-circuit sizing module. The neural network model of the sub-circuit sizing module has 3 hidden layers with 64 nodes. Table XI below summarizes the average MAPE for different specifications when the entire AnGeL is tested. An average MAPE of 0.06 is achieved in total.

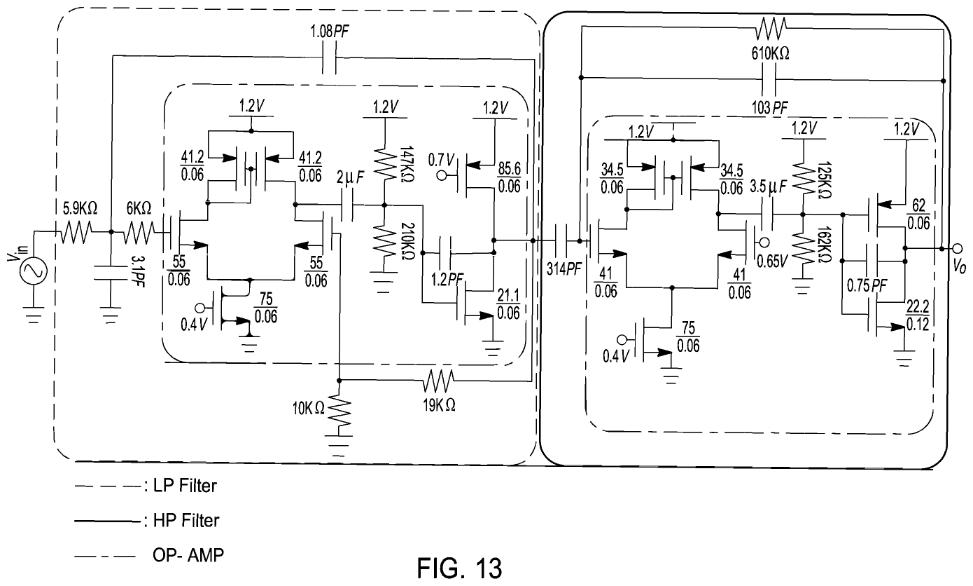

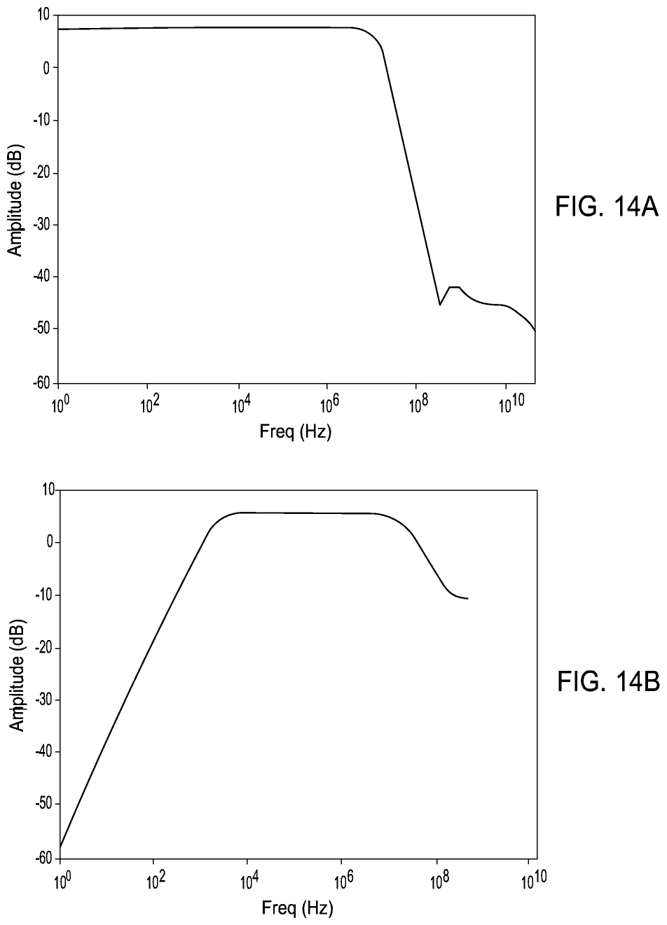

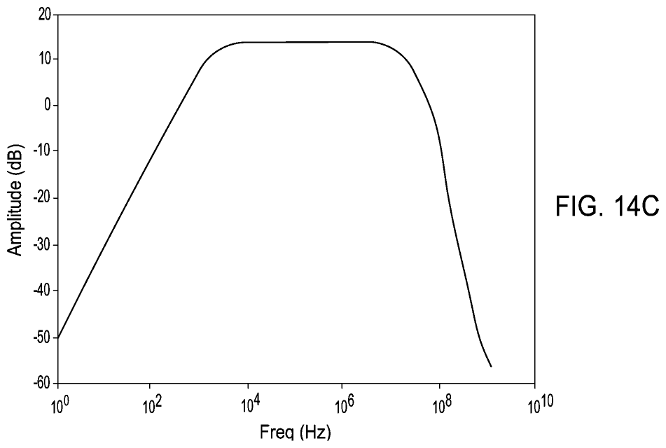

FIG. 13 demonstrates an example of a band-pass filter designed by AnGeL, which is among such 1,200 testing samples and it is generated to meet specifications that are shown in Table XII below. AnGeL has selected a Sallen-key topology for the LP filter and a TIA topology for the HP filter. There are 31 design parameters in this design. The LP and HP stage desired rows in Table XII, are generated by the overall topology decider module. The average MAPE is 0.054. FIG. 14 also illustrates the frequency responses of each LP and HP filter as well as the overall band-pass filter of FIG. 13.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### APPENDIX

TABLE I
COMPARISON COST OF ANGEL AND THE CONVENTIONAL
APPROACHES REGARDING THE CURSE OF DIMENSIONALITY.
n₁ AND n₂: NUMBER OF DESIGN PARAMETERS IN
TWO DIFFERENT SUB-CIRCUITS. k: NUMBER OF
SAMPLES FOR EACH PARAMETER

| [n₁, n₂, k] | 5, 5, 3] | 5, 5,5] | [5, 7, 4] | [7, 6, 4] | [7,7, 5] |
|---|---|---|---|---|---|
| Conventional Cost | 1,000 | 100,000 | 20,736 | 28,561 | 537,842 |
| AnGel cost | 250 | 6,250 | 3,026 | 3,697 | 33,614 |

TABLE II
STATISTICS OF TESTED SPECIFICATIONS
FOR DIFFERENT OPAMP SUB-CIRCUITS

| Sub-circuit | Specification | Min | Max | Average | SD |
|---|---|---|---|---|---|
| Gain Block | BW [GHz] | 0.001 | 15 | 0.17 | 0.68 |
| | Gain [dB] | −0.89 | 53.2 | 33.48 | 9.46 |
| | Power [mW] | 0.02 | 28.8 | 2.55 | 2.29 |
| | Noise [mV] | 0.009 | 1.31 | 0.09 | 0.06 |
| | Swing [V] | 0 | 0.95 | 0.62 | 0.21 |
| | PM [°]* | −121 | 170 | 99.8 | 35.4 |
| | GM [dB]** | −20 | 20 | 3.2 | 4.5 |
| DC-biasing | Vₒᵤₜ [V] | 0.25 | 0.8 | 0.55 | 0.12 |
| | Cᵢₙ [μF] | 5 | 99.6 | 40.1 | 10.5 |
| | Rₒᵤₜ [kΩ] | 35 | 400 | 250 | 50 |
| Current Source | Current [mA] | 0.01 | 20.4 | 1.6 | 1.5 |

*Phase margin; PM is defined only for two-stage OPAMPs.
**Gain margin; GM is defined only for two state OPAMPs

TABLE III
NUMBER OF SIMULATIONS AND GENERATED
DATA USING THE TOPOLOGY-COMBINER
MODEL FOR SIGNLE-STAGE OPAMPS

| Sub-circuit | Simulations #* | Unlabeled generated data # |
|---|---|---|
| Single-ended gain block | 7,350 | 16,400 |
| Differential gain block | 450 | 23,300 |
| Current Source | 450 | 0 |
| DC-biasing | 250 | 0 |

*#: Number.

TABLE IV
MAPE OF THE DETERMINED SPECIFICATIONS BY THE
TOPOLOGY COMBINER. MORE THAN 650 INSTANCES
FROM 17 DIFFERENT SINGLE-STAGE OPAMP TOPOLOGIES
ARE TESTED FOR EACH SPECIFICATION.

| Specification | BW | Gain | Power | Noise | Swing |
|---|---|---|---|---|---|
| MAPE | 0.070 | 0.029 | 0.049 | 0.051 | 0.038 |

TABLE V
REQUIRED NUMBER OF LABELED DATA PER TOPOLOGY
COMPARISON BETWEEN THE STATE-OF-THE-ART WORKS
TO ACHIEVE AN AVERAGE MAPE OF 0.045 IN ESTIMATING
THE FUNCTIONALITY OF OPAMPS

| Work | | | | | | | | | |
|---|---|---|---|---|---|---|---|---|---|
| Number | CCI-NN [4] | | | CCI-NN + TC* | | | AnGel | | |
| of Stages | 1 | 2 | 3 | 1 | 2 | 3 | 1 | 2 | 3 |
| Data per | 2,000 | 4,200 | 6,200 | 355 | 750 | 1,200 | 355 | 20 | 6 |
| topology | | | | | | | | | |

*TC: Topology Combiner

TABLE VI
AVERAGE RUNTIME AND MAPE COMPARISON OF
DIFFERENT SUB-CIRCUIT SIZING MODELS

| Optimization engine | | | | Run- | |
|---|---|---|---|---|---|
| Global | Local | Parameters | Estimator | time[s] | MAPE |
| NN | PSO | Iterations: 10 | NN | 34.15 | 0.059 |
| PSO | PSO | Iterations: 50, | NN | 100.4 | 0.09 |
| | | Particles: | | | |
| | | 3,000 | SPICE | 7,800,000 | 0.018 |
| SA | SA | Iterations: | NN | 2,562 | 0.17 |
| | | 5,000 | SPICE | 237,465 | 0.04 |
| BO | BO | Iterations: 500 | NN | 510 | 0.179 |
| | | | SPICE | 26,912 | 0.08 |

TABLE VII
AN EXAMPLE OF THE OPAMP SPECIFICATIONS GIVEN
TO ANGEL AND THE SIMULATED SPECIFICATIONS OF
THE ASSOCIATED GENERATED CIRCUIT BY ANGEL

| Spec | BW | | Gain | | GM | | PM | Noise | Swing | | Power |
|---|---|---|---|---|---|---|---|---|---|---|---|
| 1^{st} stage | 1.35 | GHz | 16.5 | dB | —* | | —* | 0.15 mV | 0.4 | V | 1.5 mW |
| desired | | | | | | | | | | | |
| 1^{st} stage | 1.4 | GHz | 17.1 | dB | — | | — | 0.14 mV | 0.43 | V | 1.6 mW |
| AnGel | | | | | | | | | | | |
| 2^{nd} stage | 0.9 | GHz | 17.5 | dB | — | | — | 0.15 mV | 0.50 | V | 2.4 mW |
| desired | | | | | | | | | | | |
| 2^{nd} stage | 0.94 | GHz | 17.3 | dB | — | | — | 0.15 mV | 0.53 | V | 2.2 mW |
| AnGel | | | | | | | | | | | |
| 3^{rd} stage | 1.8 | GHz | 15 | dB | — | | — | 0.15 mV | 0.75 | V | 2.4 mW |
| desired | | | | | | | | | | | |
| 3^{rd} stage | 1.7 | GHz | 15 | dB | — | | — | 0.15 mV | 0.73 | V | 2.3 mW |
| AnGel | | | | | | | | | | | |
| Overall | 15 | MHz | 49 | dB | 5 | dB | 60° | 0.23 mV | 0.75 | V | 6.3 mW |
| desired | | | | | | | | | | | |
| Overall | 15.5 | MHz | 49.4 | dB | 5.3 | dB | 62.1° | 0.22 mV | 0.73 | V | 6.1 mW |
| desired | | | | | | | | | | | |

*GM and PM is defined only for the overall circuit not for the sub-circuits

TABLE VIII
STATISTICS OF TESTED SPECIFICATIONS FOR FILTERS

| Specification | Min | Max | Average | SD |
|---|---|---|---|---|
| Pass-band BW (w_{3 dB}) [MHz] | 10⁻⁴ | 46.5 | 0.3 | 0.4 |
| Stob-band frequency [MHz] | 1.5 × 10⁻⁶ | 2.5 × 10³ | 0.12 | 0.19 |
| Gain [dB] | −13.4 | 18.6 | 2.3 | 5.2 |
| Power [mW] | 0.02 | 24.5 | 1.9 | 1.8 |
| Noise [mV] | 10⁻¹⁰ | 8 | 2.2 | 4.9 |
| Overshoot [dB] | 6 × 10⁻¹³ | 12.1 | 0.32 | 1.26 |
| Group delay [μs] | 1.5 × 10⁻⁴ | 20.7 | 0.28 | 1.3 |

*The frequency that the gain has 40 dB attenuation compared to the W_{3 dB} pass-band frequency.

TABLE IX
REQUIRED NUMBER OF LABELED DATA PER TOPOLOGY
COMPARISON BETWEEN THE STATE-OF-THE-ART WORKS
TO ACHIEVE AN AVERAGE MAPE OF 0.06 IN ESTIMATING
THE FUNCTIONALITY OF FILTERS

| Work | CCI-NN [4] | Hierarchical CCI-NN | AnGel |
|---|---|---|---|
| Non-ideal OPAMP | 1,012 | 1,012 | 212 |
| models | | | |
| Transistor-level | 4,800 | 0.0253 | 0.0032 |
| OPAMPs models | | | |

TABLE X
Model Accuracy Comparison for the Filter Topology-Selector.
There Are 8 Topologies for HP & LP and 32 Topologies
for Band-Pass & Band-Stop Filters in Total

| | | Accuracy | |
|---|---|---|---|
| | | HP & | Band-pass & |
| Model | Hyperparameters | LP | band-stop |
| Random | n_estimators = 10 | 99.68% | 99.41% |
| Forest | n_estimators = 100 | 99.71% | 99.70% |
| | n_estimators = 400 | 99.69% | 99.63% |
| SVM | Linear C = 1 | 92.16% | 86.54% |
| | Polynomial, C = 1, γ = 1, degree = 3 | 95.44% | 93.12% |
| | Sigmoid, C = 1, γ = 1 | 40.17% | 27.95% |
| | RBF, C = 1, γ = 1 | 95.45% | 90.98% |
| DNN | NN layers: [64, 64, 64] | 99.49% | 94.40% |
| | NN layers: [128, 128, 128] | 99.42% | 95.22% |
| | NN layers: [128, 128, 128, 128] | 99.74% | 94.83% |

TABLE XI
MAPE Of Determined Specifications By Running The Entire Angel
Platform. More Than 1,200 Filter Instances Are Tested

| | Pass-bound | Stop-band | | | Group |
|---|---|---|---|---|---|
| Spec | BW | frequency | Gain | Overshoot | delay |
| MAPE | 0.044 | 0.065 | 0.056 | 0.068 | 0.067 |

TABLE XII
An Example of the Filter Specifications Given to AnGeL and the Simulated
Specifications of the Associated Generated Circuit by AnGeL

| | w_{3 dB}* LP | w_{3 dB}* HP | wₛ⁺ LP | wₛHP | Gain | Power | Noise | Overshoot | Overshoot | Group |
|---|---|---|---|---|---|---|---|---|---|---|
| Specification | [MHz] | [KHz] | [MHz] | [Hz] | [dB] | [mW] | [mV] | LP [μdB] | HP [mdB] | Delay [μs] |
| Band-pass | 15 | 2 | 200 | 20 | 13 | 15 | 6 | 35 | 1 | 3 |
| desired | | | | | | | | | | |
| LP desired | 15 | — | 170 | — | 7 | 8 | 3.5 | 35 | — | 6 × 10−3 |
| LP AnGel | 15.9 | — | 172.7 | — | 7.7 | 7.56 | 3.3 | 32 | — | 6.4 × 10−3 |
| output | | | | | | | | | | |
| HP desired | — | 2 | — | 20 | 6 | 7 | 3 | — | 1 | 3 |
| HP AnGel | — | 1.9 | — | 18.9 | 6.03 | 6.8 | 2.9 | — | 1.09 | 3.2 |
| output | | | | | | | | | | |
| Band-pass | 15.9 | 1.9 | 205.1 | 18.9 | 13.73 | 14.36 | 5.9 | 32 | 1.09 | 3.2 |
| AnGel | | | | | | | | | | |

*The 3 dB bandwidth of pass-band frequencies
⁺The frequency that the gain has 40 dB attenuation compared to the was pass-band frequency.

What is claimed is:

1. A fully-automated analog circuit generator, comprising:
a topology decider configured to receive a desired specification for an analog circuit and operates to determine a topology for the analog circuit using a first machine learning algorithm, where the topology for the analog circuit specifies two or more sub-circuits for constructing the analog circuit and how the two or more sub-circuits are connected together; and
a sub-circuit generator configured to receive a desired specification for an analog circuit and the topology for the analog circuit from the topology decider, where the sub-circuit generator outputs parameter values for each circuit component comprising each of the two or more sub-circuits using a second machine learning algorithm, such that the second machine learning algorithm differs from the first machine learning algorithm.

2. The fully-automated analog circuit generator of claim 1 wherein the desired specification for the analog circuit includes gain and power.

3. The fully-automated analog circuit generator of claim 1 the topology for the analog circuit is selected by the topology decider from available topologies in a database.

4. The fully-automated analog circuit generator of claim 1 wherein the parameter values for circuit components are selected from a group consisting of voltage values, resistor values and transistor sizing.

5. The fully-automated analog circuit generator of claim 1 wherein the first machine learning algorithm is one of a random forest, a support vector machine or a neural network.

6. The fully-automated analog circuit generator of claim 1 wherein the second machine learning algorithm is neural network.

7. The fully-automated analog circuit generator of claim 1 wherein the sub-circuit generator outputs parameter values that are not included in any of the two or more sub-circuits.

8. A fully-automated analog circuit generator, comprising:
a topology decider configured to receive a desired overall specification for an analog circuit and operates to select a topology for the analog circuit from among available topologies in a database and determine a specification for each sub-circuit in the topology using a first machine learning algorithm, where the topology for the analog circuit specifies two or more sub-circuits for constructing the analog circuit and how the two or more sub-circuits are connected together; and
a sub-circuit generator configured to receive a desired overall specification for an analog circuit, the topology for the analog circuit and the specification for each sub-circuit from the topology decider, where the sub-circuit generator outputs parameter values for each circuit component comprising each of the two or more sub-circuits using a second machine learning algorithm, such that the second machine learning algorithm differs from the first machine learning algorithm.

9. The fully-automated analog circuit generator of claim 8 wherein the desired overall specification for the analog circuit includes gain and power.

10. The fully-automated analog circuit generator of claim 8 wherein the topology decider selects a topology for the analog circuit using a classifier and determines a specification for each sub-circuit in the topology using regression.

11. The fully-automated analog circuit generator of claim 8 wherein the topology decider determines specifications for each sub-circuit in a hierarchical manner.

12. The fully-automated analog circuit generator of claim 8 wherein the specification for each sub-circuit in the topology includes gain values, power values, resistor values, and capacitor values.

13. The fully-automated analog circuit generator of claim 8 wherein the parameter values for circuit components are selected from a group consisting of voltage values, resistor values and transistor sizing.

14. The fully-automated analog circuit generator of claim 8 wherein the first machine learning algorithm is one of a random forest, a support vector machine or a neural network.

15. The fully-automated analog circuit generator of claim 8 wherein the second machine learning algorithm is neural network.

16. The fully-automated analog circuit generator of claim 8 wherein the sub-circuit generator outputs parameter values that are not included in any of the two or more sub-circuits.

17. A fully-automated analog circuit generator, comprising:
a topology decider configured to receive a desired overall specification for an analog circuit and operates to select a topology for the analog circuit from among available topologies in a database using a classifier and determine a specification for each sub-circuit in the topology using regression, where the topology for the analog circuit specifies two or more sub-circuits for constructing the analog circuit and how the two or more sub-circuits are connected together; and
a sub-circuit generator configured to receive a desired overall specification for an analog circuit, the topology for the analog circuit and the specification for each sub-circuit from the topology decider, where the sub-circuit generator outputs parameter values for each circuit component comprising each of the two or more sub-circuits using another machine learning algorithm that differs from the classifier.
